(19) United States
(12) Patent Application Publication
(10) Pub. No.: US 2021/0102790 A1
(43) Pub. Date: Apr. 8, 2021

(54) BOOST THRUST ROCKET MOTOR

(71) Applicant: BAE Systems Information and Electronic Systems Integration Inc, Nashua, NH (US)

(72) Inventors: David J. Schorr, Austin, TX (US); Matthew F. Chrobak, Groton, MA (US); Thomas T. Scarberry, Harvest, AL (US); Richie Spitsberg, Manchester, NH (US); Paul E. Turner, Harvest, AL (US)

(73) Assignee: BAE Systems Information and Electronic Systems Integration Inc., Nashua, NH (US)

(21) Appl. No.: 16/595,609

(22) Filed: Oct. 8, 2019

(51) Int. Cl. F42B 15/10; F02K 9/76; F02K 9/62; F02K 9/97; F02K 9/86

(52) U.S. Cl. CPC F42B 15/10; F02K 9/763; F02K 7/18; F02K 9/97; F02K 9/86; F02K 9/62

(57) ABSTRACT

A rocket in one example includes separate chambers for storing two thrust grains: an initial thrust grain and a boost thrust grain. The initial thrust grain is stored in a first chamber and the boost thrust grain is stored in a second chamber. The initial thrust grain is ignited separately from the boost thrust grain, such as in a two-stage process where the initial thrust grain is ignited before, or at the same time as, the boost thrust grain. The initial thrust grain has a large surface area (different burn pattern) relative to the boost thrust grain, which causes the initial thrust grain to have a shorter burn time than the boost thrust grain.

### FIELD OF THE DISCLOSURE

This disclosure relates generally to the field of rockets, and more particularly, to techniques for extending the range of a rocket.

### BACKGROUND

A rocket, missile or other air-borne projectile is typically propelled by a rocket engine. A common example of a solid-fuel rocket motor uses a chemical propellant in a solid state. The propellant is a mixture of fuel and oxidizing components called a grain. The grain can be stored in a tank or chamber within the rocket case. The range of the rocket, which is the maximum distance the rocket can travel along a given trajectory, is limited to an extent by the amount of the grain stored on-board and the thrust power of the grain. The grain storage capacity of a rocket depends on several factors, including the configuration and layout of the rocket, which may be dictated by its functional and design requirements. Non-trivial issues associated with extending the range of a rocket remain due to the limitations of existing designs.

### BRIEF DESCRIPTION OF THE DRAWINGS

FIGS. 1A and 1B show an example rocket motor in accordance with an embodiment of the present disclosure.

FIG. 1C shows another example rocket motor in accordance with an embodiment of the present disclosure.

FIG. 2 shows yet another example rocket motor in accordance with an embodiment of the present disclosure.

FIG. 3 shows yet another example rocket motor in accordance with an embodiment of the present disclosure.

FIGS. 4A and 4B show yet another example rocket in accordance with an embodiment of the present disclosure.

FIG. 5 is an example graphical representation of trajectories of various rockets having different configurations, in accordance with certain embodiments of the present disclosure.

### DETAILED DESCRIPTION

Techniques are disclosed for extending the range of a rocket, including, for example, a 2.75-inch diameter fin-stabilized unguided rocket used primarily for air-to-ground roles. Such rockets can be launched from aircraft platforms as well as from land- and sea-based assets. One example is the Hydra 70 unguided rocket. In accordance with an embodiment of the present disclosure, a new grain that is more efficient than the current MK66 rocket motor is utilized. The thrust profile of the rocket motor is modified to work with the rocket to achieve greater distances. The thrust profile initially matches the existing rocket motor thrust profile. Upon completion of the initial thrust profile, the thrust profile then becomes a sustained, boost base-bleed thrust that allows the rocket motor to achieve a greater range than an existing design. The unguided rocket in some embodiments includes a precision guided kit that converts the unguided rocket into a precision guided munition.

### General Overview

A rocket motor includes separate chambers for storing two thrust grains: an initial thrust grain and a boost thrust grain. The initial thrust grain is stored in a first chamber and the boost thrust grain is stored in a second chamber. The initial thrust grain is ignited separately from the boost thrust grain, such as in a two-stage boost-bleed process where the initial thrust grain is ignited before, or at the same time as, the boost thrust grain. The initial thrust grain has a large surface area (different burn pattern) relative to the boost thrust grain, which causes the initial thrust grain to have a shorter burn time than the boost thrust grain. For example, the burn time of the initial thrust grain during the boost phase is approximately 0.5 to 1 seconds, while the burn time of the boost thrust grain during the bleed phase is approximately 20 to 40 seconds providing a long, boost burn of approximately 20 pounds of thrust or less to assist the rocket in achieving greater range at subsonic speeds. Numerous variations will be apparent.

### Example Rocket Configurations

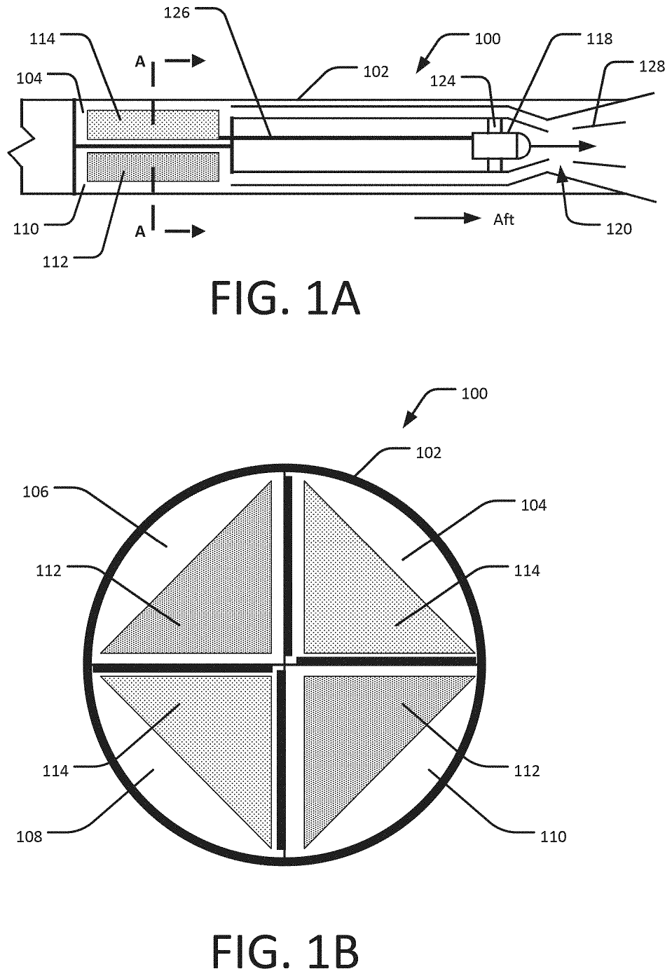

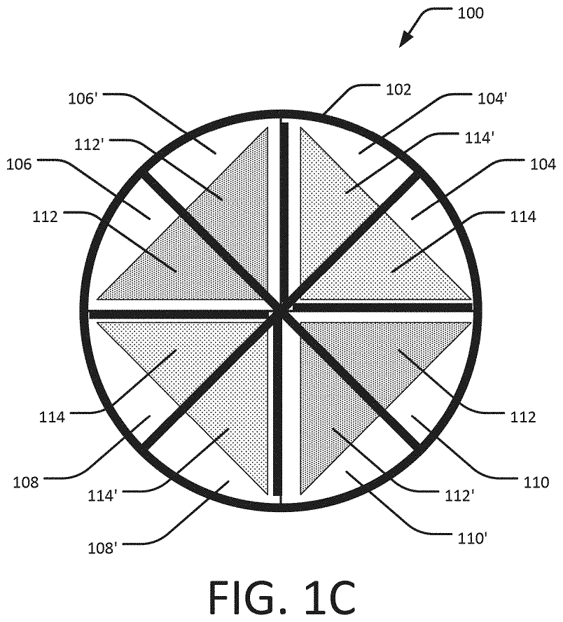

FIGS. 1A and 1B show an example of a propulsion section of a rocket 100 in accordance with an embodiment of the present disclosure. FIG. 1A is a partial side view of rocket 100. Rocket 100 is, in some embodiments, a ground-, sea-, or air-launched rocket, a composite case, and a staged motor design using multiple propellant grains. In one example rocket 100 has a 2.75-inch form-factor. FIG. 1B is a cross-sectional view of rocket 100 along cut line A-A. Rocket 100 has a case 102 with several laterally adjacent internal propellant combustion chambers 104, 106, 108 and 110. The chambers are at least partially isolated from each other or completely isolated from each other. In some cases, the chambers are formed by case 102 to minimize the inert mass needed to carry internal pressure of the motor. It will be understood that rocket 100 can include any number of chambers. In FIG. 1B, chambers 104, 106, 108, 110 are in different laterally adjacent quadrants of rocket 100 when viewed in cross-section along an axial fore-aft axis of the rocket 100, as shown. However, chambers 104, 106, 108, 110 can have different shapes than shown in FIG. 1B. Each chamber 104, 106, 108, 110 contains a propellant grain. In some embodiments, rocket 100 includes a nozzle 120 at the aft end of case 102.

One or more of chambers 104, 106, 108, 110 contain an initial thrust propellant grain 112, and the remaining chamber(s) contain a boost thrust propellant grain 114. As discussed above, the initial thrust propellant grain 112 has a large surface area (different burn pattern) relative to the boost thrust propellant grain 114, which causes the initial thrust propellant grain 112 to have a shorter burn time than the boost thrust propellant grain 114. The initial thrust propellant grain 112, when ignited, provides a primary impulse burn for rocket 100 over a relatively short period of time (e.g., up to approximately 1.5 seconds). The boost thrust propellant grain 114, when ignited, provides a boost base-bleed burn for rocket 100 over a relatively longer period of time (e.g., up to approximately 40 seconds). The boost thrust propellant grain 114 thus provides additional thrust that extends the range of rocket 100 at subsonic speeds as compared to a rocket that uses only one type of propellant grain.

In some embodiments, initial thrust propellant grain 112 includes an AA-2 propellant and boost thrust propellant grain 114 includes an M-36 propellant. In some embodiments, a third, intermediate grain separates initial thrust propellant grain 112 and boost thrust propellant grain 114. The intermediate grain is an AA-2 propellant. The intermediate grain is designed to extinguish at approximately the same time as initial thrust propellant grain 112. When the intermediate grain burns out, it ignites boost thrust propellant grain 114. In some embodiments, the intermediate grain and boost thrust propellant grain 114 are co-wrapped and inhibited so that they are cartridge-loaded together. The initial thrust propellant grain 112 in one example is wrapped and inhibited separately from the intermediate grain and boost thrust propellant grain 114 and separately cartridge-loaded in rocket 100 aft of boost thrust propellant grain 114.

Referring to FIGS. 1A and 1B, in operation, a central pintle 118 is fixed open in relation to nozzle 120 at ignition while the initial thrust propellant grain 112 burns during a boost phase. Pintle 118 is disposed within a mount 124 and is connected to a pintle rod 126, which shifts pintle 118 aft away from chambers 104 and 110 and toward nozzle 120 when the aft face of boost thrust propellant grain 114 ignites. Once initial thrust propellant grain 112 burns out, the aft face of boost thrust propellant grain 114 ignites during a bleed phase, and pintle 118 is shifted aft engaging nozzle 120. Nozzle 120 can be a canted nozzle, a USG nozzle or a standard nozzle. The amount of thrust produced by rocket 100 depends on the mass flow rate through the engine, the exit velocity of the exhaust, and the pressure at the nozzle exit. These variables depend on the design of the nozzle. The smallest cross-sectional area of the nozzle is called the throat of the nozzle. The hot exhaust flow is choked at the throat. The shifting action of pintle 118, represented by an arrow, reduces the effective throat area of nozzle 120, allowing boost thrust propellant grain 114 to burn at a reasonable pressure. Finally, boost thrust propellant grain 114 grain operates to burnout.

To extend the burn time of boost thrust propellant grain 114, the mass flow rate is reduced relative to the boost phase. For example, a radially burning grain is used for the boost phase. Because of the small burning surface during the bleed phase, a means of reducing the throat area of nozzle 120 is used. Without reducing the throat area, the motor pressure will drop too low after the boost phase and the motor may extinguish. The throat area reduction is accomplished using pintle 118 that is shifted aft into the throat of nozzle 120 after the boost phase has completed.

By partially plugging the throat of nozzle 120 with pintle 118 after the boost phase, an acceptable chamber pressure can be maintained during the bleed phase even though the mass flow rate has been reduced substantially. In this example, the pintle deployment is physically coupled to the propellant burn-back to prevent mistiming the closing of the throat. Pintle 118 remains secure until enough of the boost propellant has burned that there will not be an unacceptable pressure spike when the throat area is reduced. A sudden drop in pressure at the end of the boost phase could cause a flame-out before the pintle is deployed. A steep tail-off also presents a small window in which pintle 118 can safely deploy without causing the pressure to spike. To mitigate these risks, boost thrust propellant grain 114 is designed to have a long tail-off. During the bleed phase, the chamber pressure is low enough that the gas flow will separate from the nozzle walls and not pass through nozzle flutes 128. This eliminates nozzle torque during the bleed phase and reduces the burden on maintaining rocket guidance.

FIG. 1C shows an alternate example cross-sectional view of rocket 100 in accordance with an embodiment of the present disclosure. FIG. 1C is a cross-sectional view of rocket 100 along cut line A-A. Rocket 100 has a case 102 with several laterally adjacent internal propellant combustion chambers 104, 104′, 106, 106′, 108, 108′, 110 and 110′. The chambers are at least partially isolated from each other or completely isolated from each other. In some cases, the chambers are formed by case 102 to minimize the inert mass needed to carry internal pressure of the motor. It will be understood that rocket 100 can include any number of chambers. In FIG. 1C, chambers 104, 104′, 106, 106′, 108, 108′, 110 and 110′ are in different laterally adjacent quadrants of rocket 100 when viewed in cross-section along an axial fore-aft axis of the rocket 100, as shown. However, chambers 104, 104′, 106, 106′, 108, 108′, 110 and 110′can have different shapes than shown in FIG. 1C. Each chamber 104, 104′, 106, 106′, 108, 108′, 110 and 110′ contains at least one propellant grain.

For example, one or more of chambers 104, 104′, 106, 106′, 108, 108′, 110 and 110′ contain an initial thrust propellant grain 112 and/or 112′, and the remaining chamber(s) contain a boost thrust propellant grain 114 and/or 114′. As discussed above, initial thrust propellant grain 112, 112′ has a large surface area (different burn pattern) relative to boost thrust propellant grain 114, 114′, which causes initial thrust propellant grain 112, 112′ to have a shorter burn time than boost thrust propellant grain 114, 114′. Initial thrust propellant grain 112, 112′, when ignited, provides a primary impulse burn for rocket 100 over a relatively short period of time (e.g., up to approximately 1.5 seconds). Boost thrust propellant grain 114, 114′, when ignited, provides a boost base-bleed burn for rocket 100 over a relatively longer period of time (e.g., up to approximately 40 seconds). Boost thrust propellant grain 114, 114′ thus provides additional thrust that extends the range of rocket 100 at subsonic speeds as compared to a rocket that uses only one type of propellant grain.

In some embodiments, initial thrust propellant grain 112 can be ignited at a different time than initial thrust propellant grain 112′, for example, to provide a partially delayed initial thrust. Similarly, boost thrust propellant grain 114 can be ignited at a different time than the boost thrust propellant grain 114′, for example, to provide a partially delayed boost thrust. However, it will be understood that in some cases grains 112, 112′, 114 and 114′ can all be ignited simultaneously or nearly simultaneously, or in any time-delayed sequence relative to each other.

In some embodiments, each chamber 104, 104′, 106, 106′, 108, 108′, 110 and 110′ contains any one or more of initial thrust propellant grain 112, initial thrust propellant grain 112′, boost thrust propellant grain 114, or boost thrust propellant grain 114′. For example, chamber 104 can contain initial thrust propellant grain 112 and chamber 104′ can contain boost thrust propellant grain 114′. Any combination of chambers and grains can be implemented. Furthermore, any number of chambers and grains can be implemented (for example, two, three, four, etc., chambers each containing one or more grain types).

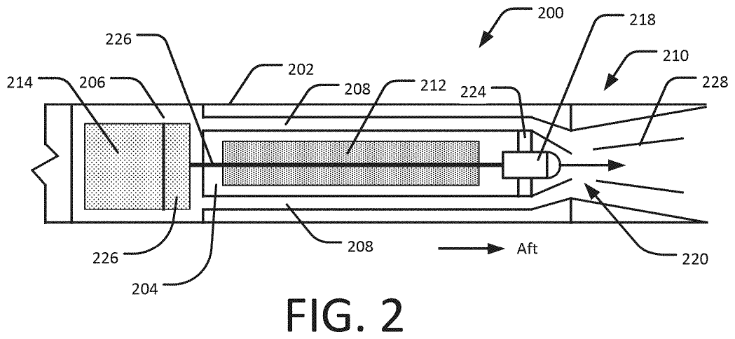

FIG. 2 shows another example rocket 200 in accordance with an embodiment of the present disclosure. FIG. 2 is a partial cross-sectional side view of the propulsion section of rocket 200. Rocket 200 is, in some embodiments, a ground-, sea-, or air-launched rocket, a composite case, and a staged motor design using multiple propellant grains. In one example rocket 200 has a 2.75-inch form-factor. Rocket 200 has a case 202 with internal propellant combustion chambers 204 and 206, and one or more channels 208 connecting chamber 206 with an exhaust portion 210 at or proximate to an aft end of rocket 200. As compared to rocket 100 of FIG. 1, chambers 204 and 206 are axially positioned such that chamber 204 is located aft of chamber 206. It will be understood that rocket 200 can include any number of chambers. Chambers 204, 206 can have different shapes and locations than shown in FIG. 2. In this example configuration, chamber 206 is in communication with exhaust portion 210 via channel 208 such that combustion occurring within chamber 206 is directed toward exhaust portion 210 via channel 208. In one example, channel 208 at least partially surrounds chamber 204 but does not necessarily surround chamber 204 completely. In another embodiment, channel 208 extends completely around the second chamber 204. For example, channel 208 can be a tube- or pencil-like structure extending from chamber 206 to exhaust portion 210. In some embodiments, there is one channel 208. In some other embodiments, there are two channels 208, such as shown in FIG. 2. In yet other embodiments, there are more than two channels 208.

Each chamber 204, 206 contains a propellant grain. Chamber 204 contains an initial thrust propellant grain 212, and chamber 206 contains a boost thrust propellant grain 214. As discussed above, initial thrust propellant 212 has a large surface area (different burn pattern) relative to boost thrust propellant grain 214, which causes initial thrust propellant grain 212 to have a shorter burn time than boost thrust propellant grain 214. Initial thrust propellant grain 212, when ignited, provides a primary impulse burn for rocket 200 over a relatively short period of time (e.g., typically up to approximately 1.5 seconds). Boost thrust propellant grain 214, when ignited, provides a boost base-bleed burn for rocket 200 over a relatively longer period of time (e.g., typically up to approximately 40 seconds). Boost thrust propellant grain 214 thus provides additional thrust that extends the range of rocket 200 at subsonic speeds as compared to a rocket that uses only one propellant grain. In some embodiments, rocket 200 includes a nozzle 220 at the aft end of case 202.

In some embodiments, initial thrust propellant grain 212 includes an AA-2 propellant and boost thrust propellant grain 214 includes an M-36 propellant. In one example, a third, intermediate grain 226 separates initial thrust propellant grain 212 and boost thrust propellant grain 214. Intermediate grain 226 in one example is an AA-2 propellant. Intermediate grain 226 is designed to extinguish at approximately the same time as initial thrust propellant grain 212. When intermediate grain 226 burns out, it ignites boost thrust propellant grain 214. In some embodiments, intermediate grain 226 and boost thrust propellant grain 214 are co-wrapped and inhibited so that they are cartridge-loaded together. Initial thrust propellant grain 212 is wrapped and inhibited separately from intermediate grain 226 and boost thrust propellant grain 214 and separately cartridge-loaded in rocket 200 aft of boost thrust propellant grain 214. Thus, in one example the boost thrust propellant grain 214 has an appended section for intermediate grain 226, or intermediate grain 226 is loaded in the same chamber 206 as boost thrust propellant grain 214.

In operation, a central pintle 218 is fixed open in relation to nozzle 220 at ignition while the initial thrust propellant grain 212 burns during a boost phase. Pintle 218 is disposed within a mount 224 and is connected to a pintle rod 226, which shifts pintle 218 aft away from chamber 204 and toward nozzle 220 when the aft face of boost thrust propellant grain 214 and/or intermediate grain 226 ignites. Once initial thrust propellant grain 212 burns out, the aft face of boost thrust propellant grain 214 and/or intermediate grain 226 ignites during a bleed phase, and pintle 218 is shifted aft engaging nozzle 220. Nozzle 220 can be a canted nozzle, a USG nozzle or a standard nozzle. The amount of thrust produced by rocket 200 depends on the mass flow rate through the engine, the exit velocity of the exhaust, and the pressure at the nozzle exit. These variables depend on the design of the nozzle. The smallest cross-sectional area of the nozzle is called the throat of the nozzle. The hot exhaust flow is choked at the throat. The shifting action of pintle 218, represented by arrows, reduces the effective throat area of nozzle 220, allowing boost thrust propellant grain 214 to burn at a reasonable pressure. Finally, boost thrust propellant grain 214 grain operates to burnout.

To extend the burn time of boost thrust propellant grain 214, the mass flow rate is reduced relative to the boost phase. For example, a radially burning grain is used for the boost phase. Because of the small burning surface during the bleed phase, a means of reducing the throat area of nozzle 220 is used. Without reducing the throat area, the motor pressure will drop too low after the boost phase and the motor may extinguish. The throat area reduction is accomplished using pintle 218 that is shifted aft into the throat of nozzle 220 after the boost phase has completed.

By partially plugging the throat of nozzle 220 with pintle 218 after the boost phase, an acceptable chamber pressure can be maintained during the bleed phase even though the mass flow rate has been reduced substantially. The pintle deployment is physically coupled to the propellant burn-back to prevent mistiming the closing of the throat. Pintle 218 remains secure until enough of the boost propellant has burned that there will not be an unacceptable pressure spike when the throat area is reduced. A sudden drop in pressure at the end of the boost phase could cause a flame-out before pintle 218 is deployed. A steep tail-off also presents a small window in which pintle 218 can safely deploy without causing the pressure to spike. To mitigate these risks, boost thrust propellant grain 214 is designed to have a long tail-off. During the bleed phase, the chamber pressure is low enough that the gas flow will separate from the nozzle walls and not pass through nozzle flutes 228. This reduces or eliminates nozzle torque during the bleed phase and reduces the burden on maintaining rocket guidance.

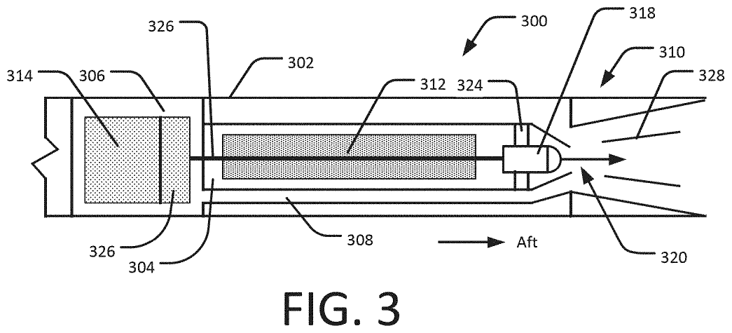

FIG. 3 shows another example rocket 300 in accordance with an embodiment of the present disclosure. FIG. 3 is a partial cross-sectional side view of the propulsion section of rocket 300. Rocket 300 is, in some embodiments, a ground-, sea-, or air-launched rocket, a composite case, and a staged motor design using multiple propellant grains. In one example rocket 300 has a 2.75-inch form-factor. Rocket 300 has a case 302 with internal propellant combustion chambers 304 and 306, and a channel 308 connecting chamber 306 with an exhaust portion 310 at or proximate to an aft end of rocket 300. As compared to rocket 100 of FIG. 1, chambers 304 and 306 are axially positioned such that chamber 304 is located aft of chamber 306. As compared to rocket 200 of FIG. 2, which has one or more channels, rocket 300 has a single channel 308. It will be understood that rocket 300 can include any number of chambers. Chambers 304, 306 can have different shapes and locations than shown in FIG. 3. In this example configuration, chamber 306 is in communication with exhaust portion 310 via channel 308 such that combustion occurring within chamber 306 is directed toward exhaust portion 310 via channel 308. Each channel 308 at least partially surrounds chamber 304 but may or may not necessarily surround chamber 304 completely. For example, channel 308 can be a tube- or pencil-like structure extending from chamber 306 to exhaust portion 310.

Each chamber 304, 306 contains a propellant grain. Chamber 304 contains an initial thrust propellant grain 312, and chamber 306 contains a boost thrust propellant grain 314. As discussed above, initial thrust propellant 312 has a large surface area (different burn pattern) relative to boost thrust propellant grain 314, which causes initial thrust propellant grain 312 to have a shorter burn time than boost thrust propellant grain 314. Initial thrust propellant grain 312, when ignited, provides a primary impulse burn for rocket 300 over a relatively short period of time (e.g., typically up to approximately 1.5 seconds). Boost thrust propellant grain 314, when ignited, provides a boost base-bleed burn for rocket 300 over a relatively longer period of time (e.g., typically up to approximately 40 seconds). Boost thrust propellant grain 314 thus provides additional thrust that extends the range of rocket 300 at subsonic speeds as compared to a rocket that uses only one propellant grain. In some embodiments, rocket 300 includes a nozzle 320 at the aft end of case 302.

In some embodiments, initial thrust propellant grain 312 includes an AA-2 propellant and boost thrust propellant grain 314 includes an M-36 propellant. In some embodiments, a third, intermediate grain 326 separates initial thrust propellant grain 312 and boost thrust propellant grain 314. Intermediate grain 326 is an AA-2 propellant. Intermediate grain 326 is designed to extinguish at approximately the same time as initial thrust propellant grain 312. When intermediate grain 326 burns out, it ignites boost thrust propellant grain 314. In some embodiments, intermediate grain 326 and boost thrust propellant grain 314 are co-wrapped and inhibited so that they are cartridge-loaded together. Initial thrust propellant grain 312 is wrapped and inhibited separately from intermediate grain 326 and boost thrust propellant grain 314 and separately cartridge-loaded in rocket 300 aft of boost thrust propellant grain 314. Thus, in one example the boost thrust propellant grain 314 has an appended section for intermediate grain 326, or intermediate grain 326 is loaded in the same chamber 306 as boost thrust propellant grain 314.

In operation, a central pintle 318 is fixed open in relation to a nozzle 320 at ignition while the initial thrust propellant grain 312 burns during a boost phase. Pintle 318 is disposed within a mount 324 and is connected to a pintle rod 326, which shifts pintle 318 aft away from chamber 304 and toward nozzle 320 when the aft face of boost thrust propellant grain 314 and/or intermediate grain 326 ignites. Once initial thrust propellant grain 312 burns out, the aft face of boost thrust propellant grain 314 and/or intermediate grain 326 ignites during a bleed phase, and pintle 318 is shifted aft engaging nozzle 320. Nozzle 320 can be a canted nozzle, a USG nozzle or a standard nozzle. The amount of thrust produced by rocket 300 depends on the mass flow rate through the engine, the exit velocity of the exhaust, and the pressure at the nozzle exit. These variables depend on the design of the nozzle. The smallest cross-sectional area of the nozzle is called the throat of the nozzle. The hot exhaust flow is choked at the throat. The shifting action of pintle 318, represented by an arrow, reduces the effective throat area of nozzle 320, allowing boost thrust propellant grain 314 to burn at a reasonable pressure. Finally, boost thrust propellant grain 314 grain operates to burnout.

To extend the burn time of boost thrust propellant grain 314, the mass flow rate is reduced relative to the boost phase. For example, a radially burning grain is used for the boost phase. Because of the small burning surface during the bleed phase, a means of reducing the throat area of nozzle 320 is used. Without reducing the throat area, the motor pressure drops after the boost phase and the motor could extinguish. The throat area reduction is accomplished with a modified pintle that is shifted aft into the throat of nozzle 320 after the boost phase has completed.

By partially plugging the throat with pintle 318 after the boost phase, an acceptable chamber pressure can be maintained during the bleed phase even though the mass flow rate has been reduced substantially. The pintle deployment is physically coupled to the propellant burn-back to prevent mistiming the closing of the throat. Pintle 318 remains secure until enough of the boost propellant has burned that there will not be an unacceptable pressure spike when the throat area is reduced. A sudden drop in pressure at the end of the boost phase could cause a flame-out before the pintle is deployed. A steep tail-off also presents a small window in which pintle 318 can safely deploy without causing the pressure to spike. To mitigate these risks, boost thrust propellant grain 314 is designed to have a long tail-off. During the bleed phase, the chamber pressure is low enough that the gas flow will separate from the nozzle walls and not pass through nozzle flutes 328. This eliminates nozzle torque during the bleed phase and reduces the burden on maintaining rocket guidance.

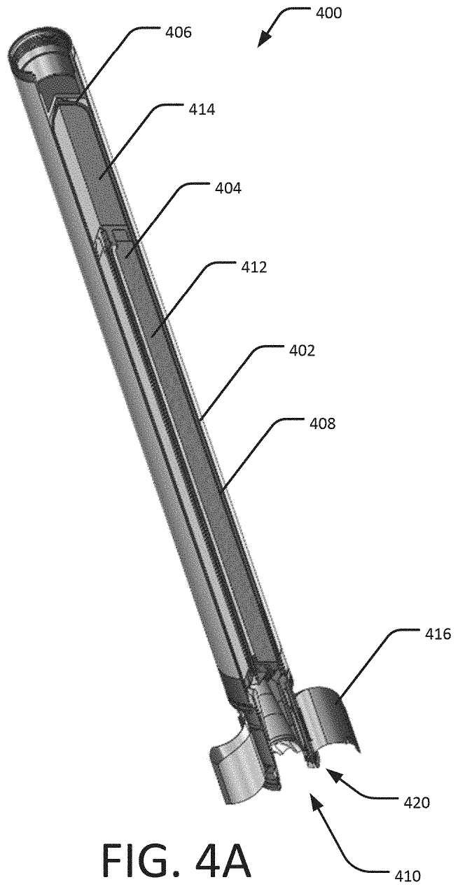

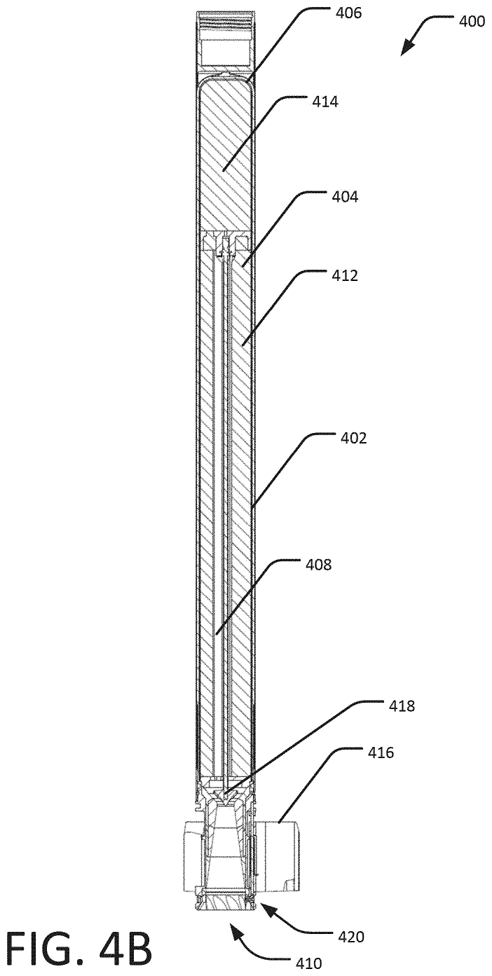

FIGS. 4A and 4B show another example for the propulsion section of rocket 400 in accordance with an embodiment of the present disclosure. FIG. 4A is a partial cross-sectional perspective view of rocket 400. FIG. 4B is a partial cross-sectional side view of rocket 400. Rocket 400 is, in some embodiments, a ground-, sea-, or air-launched rocket, a composite case, and a staged motor design using multiple propellant grains. In one example rocket 400 has a 2.75-inch form-factor. Rocket 400 has a case 402 with internal propellant combustion chambers 404 and 406, and a channel 408 connecting chamber 406 with an exhaust portion 410 at or proximate to an aft end of rocket 400. It will be understood that rocket 400 can include any number of chambers. Rocket 400 further includes one or more fins 416 mounted proximate to the aft end for flight stability and to maintain orientation and trajectory along an intended flight path. Chambers 404, 406 can have different shapes and locations than shown in FIG. 4. In this example configuration, chamber 406 is in communication with exhaust portion 410 via channel 408 such that combustion occurring within chamber 406 is directed toward exhaust portion 410 via channel 408. Each channel 408 at least partially surrounds chamber 404 and may or may not necessarily surround chamber 404 completely. For example, channel 408 can be a tube- or pencil-like structure extending from chamber 406 to exhaust portion 410.

Each chamber 404, 406 contains a propellant grain. Chamber 404 contains an initial thrust propellant grain 412, and chamber 406 contains a boost thrust propellant grain 414. As discussed above, initial thrust propellant 412 has a large surface area (different burn pattern) relative to boost thrust propellant grain 414, which causes initial thrust propellant grain 412 to have a shorter burn time than boost thrust propellant grain 414. Initial thrust propellant grain 412, when ignited, provides a primary impulse burn for rocket 400 over a relatively short period of time (e.g., typically up to approximately 1.5 seconds). Boost thrust propellant grain 414, when ignited, provides a boost base-bleed burn for rocket 400 over a relatively longer period of time (e.g., typically up to approximately 40 seconds). Boost thrust propellant grain 414 thus provides additional thrust that extends the range of rocket 400 at subsonic speeds as compared to a rocket that uses only one propellant grain.

In some embodiments, initial thrust propellant grain 412 includes an AA-2 propellant and boost thrust propellant grain 414 includes an M-36 propellant. In some embodiments, a third, intermediate grain separates initial thrust propellant grain 412 and boost thrust propellant grain 414. The intermediate grain is an AA-2 propellant. The intermediate grain is designed to extinguish at approximately the same time as initial thrust propellant grain 412. When the intermediate grain burns out, it ignites boost thrust propellant grain 414. In some embodiments, the intermediate grain and boost thrust propellant grain 414 are co-wrapped and inhibited so that they are cartridge-loaded together. The initial thrust propellant grain 412 is wrapped and inhibited separately from the intermediate grain and boost thrust propellant grain 414 and separately cartridge-loaded in rocket 400 aft of boost thrust propellant grain 414.

In operation, a central pintle 418 is fixed open in relation to a nozzle 420 at ignition while the initial thrust propellant grain 412 burns during a boost phase. In some cases, initial thrust propellant grain 412 includes an intermediate grain and a boost grain, which have the same burn time. Once initial thrust propellant grain 412 burns out, the aft face of boost thrust propellant grain 414 ignites during a bleed phase, and the pintle rod is shifted aft engaging nozzle 420. Nozzle 420 can be a canted nozzle, a USG nozzle or a standard nozzle. The amount of thrust produced by rocket 400 depends on the mass flow rate through the engine, the exit velocity of the exhaust, and the pressure at the nozzle exit. These variables depend on the design of the nozzle. The smallest cross-sectional area of the nozzle is called the throat of the nozzle.

The hot exhaust flow is choked at the throat. The shifting action reduces the effective throat area of nozzle 420, allowing boost thrust propellant grain 414 to burn at a reasonable pressure. Finally, boost thrust propellant grain 414 grain operates to burnout.

To extend the burn time of boost thrust propellant grain 414, the mass flow rate is reduced relative to the boost phase. For example, a radially burning grain is used for the boost phase. Because of the small burning surface during the bleed phase, a means of reducing the throat area of nozzle 320 is used. Without reducing the throat area, the motor pressure will drop lower after the boost phase and the motor may extinguish. The throat area reduction is accomplished with a modified pintle that is shifted aft into the throat of nozzle 420 after the boost phase has completed.

By partially plugging the throat with pintle 418 after the boost phase, an acceptable chamber pressure can be maintained during the bleed phase even though the mass flow rate has been reduced substantially. The pintle deployment is physically coupled to the propellant burn-back in order to prevent mistiming the closing of the throat. Pintle 418 remains secure until enough of the boost propellant has burned that there will not be an unacceptable pressure spike when the throat area is reduced. A sudden drop in pressure at the end of the boost phase could cause a flame-out before the pintle is deployed. A steep tail-off also presents a small window in which pintle 418 can safely deploy without causing the pressure to spike. To mitigate these risks, boost thrust propellant grain 414 is designed to have a long tail-off. During the bleed phase, the chamber pressure is low enough that the gas flow will separate from the nozzle walls and not pass through the nozzle flutes. This eliminates nozzle torque during the bleed phase and reduces the burden on maintaining rocket guidance.

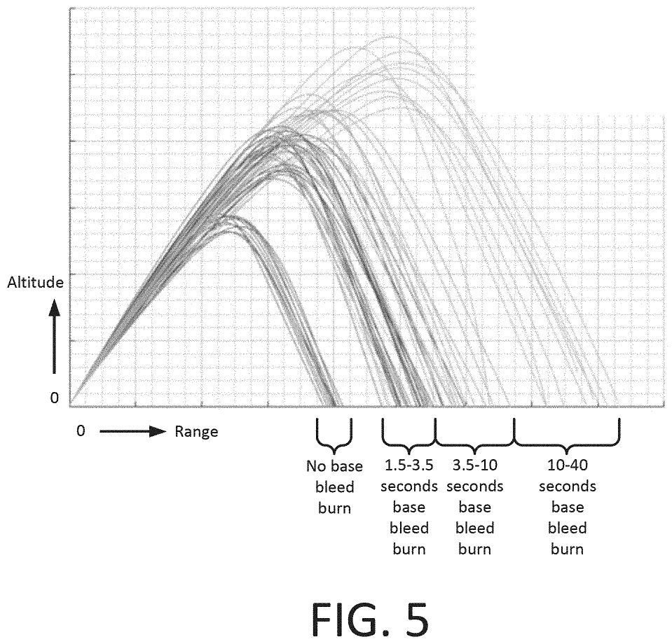

FIG. 5 is an example graphical representation of trajectories of various rockets having different configurations, in accordance with certain embodiments of the present disclosure. The vertical axis of the graph represents height or altitude of the rocket and the horizontal axis of the graph represents ground distance or range of the rocket. As can be seen in FIG. 3, for a given trajectory, the range of the rocket increases in relation to the base bleed burn time as a result of achieving a greater altitude than the rocket would achieve without any base bleed burn.

Numerous embodiments will be apparent in light of the present disclosure, and features described herein can be combined in any number of configurations. One example embodiment provides a rocket including a case having a first propellant combustion chamber and a second propellant combustion chamber; an initial thrust propellant grain contained in the first propellant combustion chamber, the initial thrust propellant grain configured to provide, during a boost phase, a primary impulse burn for the rocket; and a boost thrust propellant grain contained in the second propellant combustion chamber, the boost thrust propellant grain configured to provide, during a bleed phase, a boost base-bleed burn for the rocket over a longer period of time relative to the primary impulse burn. In some cases, the first propellant combustion chamber is laterally adjacent to the second propellant combustion chamber. In some cases, the rocket includes a third combustion chamber laterally adjacent to the first and second combustion chambers, where one of the initial thrust propellant grain and the boost thrust propellant grain is contained in the third combustion chamber. In some such cases, the rocket includes a fourth combustion chamber laterally adjacent to the first, second, and third combustion chambers, where one of the initial thrust propellant grain and the boost thrust propellant grain is contained in the fourth combustion chamber. In some cases, the first propellant combustion chamber is positioned aft of the second propellant combustion chamber. In some cases, the boost thrust propellant grain is configured to be ignited after the initial thrust propellant grain is ignited. In some cases, the case is a 2.75-inch diameter fin-stabilized unguided rocket case. In some cases, the rocket includes a nozzle at or proximate to an aft end of the rocket, and a pintle, the pintle configured to shift from an open position relative to the nozzle during the boost phase aft to engage the nozzle during the bleed phase, thereby reducing an effective throat area of the nozzle. In some cases, the rocket includes an intermediate grain configured to be ignited during the boost phase.

A further embodiment is a precision guided munition such as a Hydra rocket with an APKWS® precision guidance kit. The warhead and fuze are generally located on the forward section of the rocket with the guidance kit proximate the mid-section and the booster assembly located on the aft side of the rocket. A guidance navigation and control (GNC) section is mid-body and typically includes canards that are used to steer the rocket to the target. Sensors are used to aid in guiding the rocket to the target. The propulsion section is on the aft or rear section of the rocket and typically has stabilizer fins. The improved propulsion section detailed herein provides for a longer range and/or improved capability in accurately reaching a target.

Another example embodiment provides a rocket including a case having a first propellant combustion chamber and a second propellant combustion chamber; an initial thrust propellant grain contained in the first propellant combustion chamber, the initial thrust propellant grain configured to provide, during a boost phase, a primary impulse burn for the rocket; a boost thrust propellant grain contained in the second propellant combustion chamber, the boost thrust propellant grain configured to provide, during a bleed phase, a boost base-bleed burn for the rocket over a longer period of time relative to the primary impulse burn; and at least one channel connecting the second propellant combustion chamber with an exhaust portion at or proximate to an aft end of the rocket and configured to direct combustion exhaust from the second propellant combustion chamber toward the aft end of the rocket. In some cases, the first propellant combustion chamber is in communication with the aft end of the rocket. In some cases, the at least one channel at least partially surrounds the first propellant combustion chamber. In some cases, the rocket includes at least two channels connecting the second propellant combustion chamber with the exhaust portion of the rocket. In some cases, the boost thrust propellant grain is configured to be ignited after the initial thrust propellant grain is ignited. In some cases, the case is a 2.75-inch diameter fin-stabilized rocket case. In some cases, the rocket includes a nozzle at or proximate to the aft end of the rocket, and a pintle, the pintle configured to shift from an open position relative to the nozzle during the boost phase aft to engage the nozzle during the bleed phase, thereby reducing an effective throat area of the nozzle. In some cases, the rocket includes an intermediate grain configured to be ignited during the boost phase.

Yet another example embodiment provides a kit including a case having a first propellant combustion chamber and a second propellant combustion chamber; an initial thrust propellant grain configured to be contained in the first propellant combustion chamber, the initial thrust propellant grain configured to provide, during a boost phase, a primary impulse burn for the rocket; and a boost thrust propellant grain configured to be contained in the second propellant combustion chamber, the boost thrust propellant grain configured to provide, during a bleed phase, a boost base-bleed burn for the rocket over a longer period of time relative to the primary impulse burn. In some cases, the first propellant combustion chamber is laterally adjacent to the second propellant combustion chamber. In some cases, the kit includes a third combustion chamber laterally adjacent to the first and second combustion chambers, where one of the initial thrust propellant grain and the boost thrust propellant grain is configured to be contained in the third combustion chamber. In some cases, the kit includes a nozzle at or proximate to an aft end of the case, and a pintle, the pintle configured to shift from an open position relative to the nozzle during the boost phase aft to engage the nozzle during the bleed phase, thereby reducing an effective throat area of the nozzle. In some cases, the kit includes at least one channel connecting the second propellant combustion chamber with an exhaust portion at or proximate to an aft end of the rocket and configured to direct combustion exhaust from the second propellant combustion chamber toward the aft end of the rocket. In some cases, the case is a 2.75-inch diameter fin-stabilized unguided rocket case. In some cases, the rocket includes an intermediate grain configured to be ignited during the boost phase.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

What is claimed is:

1. A rocket comprising:
a case having a first propellant combustion chamber and a second propellant combustion chamber;
an initial thrust propellant grain contained in the first propellant combustion chamber, the initial thrust propellant grain configured to provide, during a boost phase, a primary impulse burn for the rocket; and
a boost thrust propellant grain contained in the second propellant combustion chamber, the boost thrust propellant grain configured to provide, during a bleed phase, a boost base-bleed burn for the rocket over a longer period of time relative to the primary impulse burn.

2. The rocket of claim 1, wherein the first propellant combustion chamber is laterally adjacent to the second propellant combustion chamber.

3. The rocket of claim 1, further comprising a third combustion chamber laterally adjacent to the first and second combustion chambers, wherein one of the initial thrust propellant grain and the boost thrust propellant grain is contained in the third combustion chamber.

4. The rocket of claim 3, wherein the first propellant combustion chamber is positioned aft of the second propellant combustion chamber.

5. The rocket of claim 1, wherein the boost thrust propellant grain is configured to be ignited after the initial thrust propellant grain is ignited.

6. The rocket of claim 1, further comprising an intermediate grain configured to be ignited during the boost phase.

7. The rocket of claim 1, further comprising a nozzle at or proximate to an aft end of the rocket, and a pintle, the pintle configured to shift from an open position relative to the nozzle during the boost phase aft to engage the nozzle during the bleed phase, thereby reducing an effective throat area of the nozzle.

8. A rocket comprising:
a case having a first propellant combustion chamber and a second propellant combustion chamber;
an initial thrust propellant grain contained in the first propellant combustion chamber, the initial thrust propellant grain configured to provide, during a boost phase, a primary impulse burn for the rocket;
a boost thrust propellant grain contained in the second propellant combustion chamber, the boost thrust propellant grain configured to provide, during a bleed phase, a boost base-bleed burn for the rocket over a longer period of time relative to the primary impulse burn; and
at least one channel connecting the second propellant combustion chamber with an exhaust portion at or proximate to an aft end of the rocket and configured to direct combustion exhaust from the second propellant combustion chamber toward the aft end of the rocket.

9. The rocket of claim 8, wherein the first propellant combustion chamber is in communication with the aft end of the rocket.

10. The rocket of claim 8, wherein the at least one channel at least partially surrounds the first propellant combustion chamber.

11. The rocket of claim 8, further comprising at least two channels connecting the second propellant combustion chamber with the exhaust portion of the rocket.

12. The rocket of claim 8, wherein the boost thrust propellant grain is configured to be ignited after the initial thrust propellant grain is ignited.

13. The rocket of claim 8, wherein the case is a 2.75-inch diameter fin-stabilized rocket case.

14. The rocket of claim 8, further comprising a nozzle at or proximate to the aft end of the rocket, and a pintle, the pintle configured to shift from an open position relative to the nozzle during the boost phase aft to engage the nozzle during the bleed phase, thereby reducing an effective throat area of the nozzle.

15. A precision guided munition kit comprising:
a warhead;
a fuze for setting a detonation of the warhead;
a guidance, navigation and control section for guiding the precision guided munition to a target; and
a propulsion section comprising:
a case having a first propellant combustion chamber and a second propellant combustion chamber;
an initial thrust propellant grain configured to be contained in the first propellant combustion chamber, the initial thrust propellant grain configured to provide, during a boost phase, a primary impulse burn for the rocket; and
a boost thrust propellant grain configured to be contained in the second propellant combustion chamber, the boost thrust propellant grain configured to provide, during a bleed phase, a boost base-bleed burn for the rocket over a longer period of time relative to the primary impulse burn.

16. The kit of claim 15, wherein the first propellant combustion chamber is laterally adjacent to the second propellant combustion chamber.

17. The kit of claim 15, wherein the first propellant combustion chamber is positioned aft of the second propellant combustion chamber.

18. The kit of claim 15, further comprising a nozzle at or proximate to an aft end of the case, and a pintle, the pintle configured to shift from an open position relative to the nozzle during the boost phase aft to engage the nozzle during the bleed phase, thereby reducing an effective throat area of the nozzle.

19. The kit of claim 15, further comprising at least one channel connecting the second propellant combustion chamber with an exhaust portion at or proximate to an aft end of the rocket and configured to direct combustion exhaust from the second propellant combustion chamber toward the aft end of the rocket.

20. The kit of claim 15, wherein the precision guided munition is a 2.75-inch diameter fin-stabilized rocket.
